(19) United States
(12) Patent Application Publication
(10) Pub. No.: US 2010/0190433 A1
(43) Pub. Date: Jul. 29, 2010

(54) RELAY DEVICE AND WIRELESS COMMUNICATION METHOD THEREOF

(75) Inventors: Yuantao ZHANG, Beijing (CN); Jian WANG, Beijing (CN); Yuanrong LAN, Beijing (CN); Hua ZHOU, Beijing (CN); Jun TIAN, Beijing (CN)

Correspondence Address: MYERS WOLIN, LLC, 100 HEADQUARTERS PLAZA, North Tower, 6th Floor, MORRISTOWN, NJ, 07960-6834, US

(73) Assignee: FUJITSU LIMITED, Kawasaki-shi (JP)

(21) Appl. No.: 12/634,025

(22) Filed: Dec. 9, 2009

(30) Foreign Application Priority Data
Jan. 23, 2009 (CN) 200910008553.0

(51) Int. Cl. H04B 7/14; H04J 3/00

(52) U.S. Cl. 455/7; 370/280

(57) ABSTRACT

The invention provides a relay device and a wireless communication method thereof. The A wireless communication method for a relay device includes the following steps: receiving a first signal destined for a second communication device from a first communication device; decoding the received first signal and determining whether a decoding result is correct; generating a first decoding response signal indicating whether the decoding result of the first signal is correct; and sending the first decoding response signal to the first communication device and the second communication device.

### CROSS REFERENCE TO RELATED APPLICATIONS

This application is based upon and claims the benefit of priority of the prior Chinese Patent Application No. 200910008553.0, filed on Jan. 23, 2009, now pending, the contents of which are herein wholly incorporated by reference.

### FIELD OF THE INVENTION

The present invention relates to the field of wireless communication system, particularly to relay device and wireless communication method thereof.

### BACKGROUND

With the rapid development of the wireless multimedia service, the user's requirements on the data communication ability and transmission quality are becoming increasingly higher. However, many communication dead-spots arise due to the effect of such factors as block, shading in the complex wireless environment. Those make it difficult for the users to obtain continuous high speed and high quality communication service. In order to solve this problem, in the wireless system, a relay device is utilized to forward the wireless communication signal between the wireless communication parties to thereby improve the throughput of the system and the user data rate.

A wires communication system utilizing a relay device generally includes a transmitting communication device, a relay device and a receiving communication device. The relay device receives the signal from the transmitting communication device, and performs certain processing, then forwards it to the receiving communication device. There are generally two modes for the relay device to process signals. One is Amplify and Forward (AF), and the other is Decode and Forward (DF).

The so-called Amplify and Forward is to amplify the received signal at the RF side and send the amplified signal. The method is advantageous in that the signal process flow is simple and the cost of the device is relatively low. However, the system noise is also amplified while increasing the signal strength, thereby bringing out the disadvantage of accumulated noise.

The so-called Decode and Forward is to decode the signal from the transmitting communication device in the relay device, to completely restore the signal, and then to forward the re-encoded signal to the receiving communication device at certain power. The Decode and Forward device completely eliminates the noise accumulation during the transmission, enables long distance communication with large volume and high quality, has flexible link adaptation performance and enhanced security performance, and can combine with the space-time processing technology to provide a good space diversity effect. However, if an error occurs in the decoding of the relay device, error propagation will occurs in the forwarded signal, and also cannot be restored by the receiving communication device.

FIG. 1 shows the communication method for the wireless communication system including the relay device in the prior art. In FIG. 1, the transmitting communication device S performs the first transmission at time slot t to send the signal to the relay device RS and the receiving communication device D. The relay device RS decodes the received signal, and re-encodes the decoded data to eliminate the effect of the noise. At time slot t+n, the second transmission is performed to send the re-encoded data to the receiving communication device D. Upon receiving the signal sent from the relay device RS, the receiving communication device D synthesizes it with the data sent from the transmitting communication device S received at time slot t, and then decodes the same.

FIG. 2 shows another communication method for the wireless communication system including relay device in the prior art. In FIG. 2, at time slot t, two communication devices C and D send the signals to the relay device RS simultaneously. The relay device RS decodes the received two signals, and processes the decoded two signals, for example by performing a bit-level exclusive OR operation to the two signals. At time slot t+n, the processed signal is sent to the two communication devices S and D simultaneously.

As described above, it can't be ensured that, after a signal is received by the relay device RS from the transmitting communication device S, the signal is received completely correctly. If the signal is not correctly received and still be forwarded, the receiving communication device D can not correctly restore the signal after receiving the forwarded signal. There was proposed a method in U.S. patent application US 20070245204, entitled “Retransmitting apparatus and method using relay station in a multi-hop network”, proposed by Hiroyuki Yomo et al., in which the relay device sends the decoding response signal indicating whether the decoding result is correct to the transmitting communication device, to ensure that the relay device forwards no signal when the decoding result is not correct. However, in this method, the receiving communication device does not know whether the decoding result of the relay device is correct, therefore still gets prepared for receiving signal, which might cause resource waste of the communication system.

### SUMMARY OF THE INVENTION

In view of this, a mechanism in which the receiving communication device also knows whether the decoding result of the relay device is correct is proposed in the present invention.

According to one aspect of the invention, there is provided a wireless communication method for a relay device, including: receiving a first signal destined for a second communication device from a first communication device; decoding the received first signal and determining whether a decoding result is correct; generating a first decoding response signal indicating whether the decoding result of the first signal is correct; and sending the first decoding response signal to the first communication device and the second communication device.

According to another aspect of the invention, there is provided a relay device for a wireless communication system, including: a transceiver configured to receive a first signal destined for a second communication device from a first communication device; a decoder configured to decode the first signal and determine whether a decoding result is correct; a decoding response signal generator configured to generate a first decoding response signal indicating whether the decoding result of the first signal is correct, wherein, the transceiver is further configured to send the first decoding response signal to the first communication device and the second communication device.

The present invention enables the receiving communication device to know whether the decoding result of the relay device is correct, thereby making it possible to more effectively utilize the resources of the communication system.

These and further aspects and features of the present invention will become more clear by referring to the following description and accompanying drawings. In the description and accompanying drawings, particular embodiments of the invention are disclosed in detail, and the method in which the principle of the present invention may be employed is indicated. It should be understood that the present invention is not thereby limited in scope. There may be various alterations, modifications and equivalents of the invention within the scope of the spirit and provisions of the accompanying claims.

A feature described and/or shown for one embodiment may be utilized in one or more other embodiments in the same or similar way, or may be combined with or replace a feature in other embodiments.

It should be noted that the term “include/contain” when used in the specification indicates the presence of the feature, whole piece, step or component, without excluding the presence or addition of one or more other features, whole pieces, steps or components.

Many aspects of the invention can be better understood with reference to the accompanying drawings. The parts in the figures are not drawn to scale, just for illustrating the principle of the invention. For the convenience of illustrating and describing some part of the invention, the corresponding part in the accompanying drawings may be enlarged, that is, it may look bigger compared to other parts in the illustrative device manufactured in practice according to the invention. The elements and features described in one accompanying drawing or one embodiment of the invention may be combined with the elements and features shown in one or more other accompanying drawings or embodiments. Further, in the accompanying drawings, similar reference numerals indicate the corresponding parts through several accompanying drawings, and may be used to indicate the corresponding parts used in more than one embodiment.

### BRIEF DESCRIPTION OF THE DRAWINGS

The accompanying drawings, which illustrate the preferred embodiments of the invention and constitutes a part of the specification, are used to further explain the principle of the invention in detail together with the description, wherein:

FIG. 1 illustrates a communication method for a wireless communication system including a relay device in the prior art;

FIG. 2 illustrates another communication method for a wireless communication system including a relay device in the prior art;

FIG. 3 schematically illustrates a wireless communication method according to one embodiment of the present invention;

FIG. 4 schematically illustrates a wireless communication method according to another embodiment of the present invention;

FIG. 5 and FIG. 6 schematically illustrate a time chart for the signal transceiving of the TDD wireless communication system according to one embodiment of the present invention;

FIG. 7 schematically illustrates a time chart for the signal transceiving of the TDD wireless communication system according to another embodiment of the present invention;

FIG. 8 is a flow chart for a wireless communication method for a relay device according to one embodiment of the present invention;

FIG. 9 is a flow chart for a wireless communication method for a relay device according to another embodiment of the present invention;

FIG. 10 is a flow chart for a wireless communication method for a relay device according to another embodiment of the present invention;

FIG. 11 is a block diagram for a relay device for a wireless communication system according to one embodiment of the present invention;

FIG. 12 is a block diagram for a relay device for a wireless communication system according to another embodiment of the present invention;

FIG. 13 is a block diagram for a relay device for a wireless communication system according to another embodiment of the present invention;

FIG. 14 is a block diagram for a relay device for a wireless communication system according to another embodiment of the present invention;

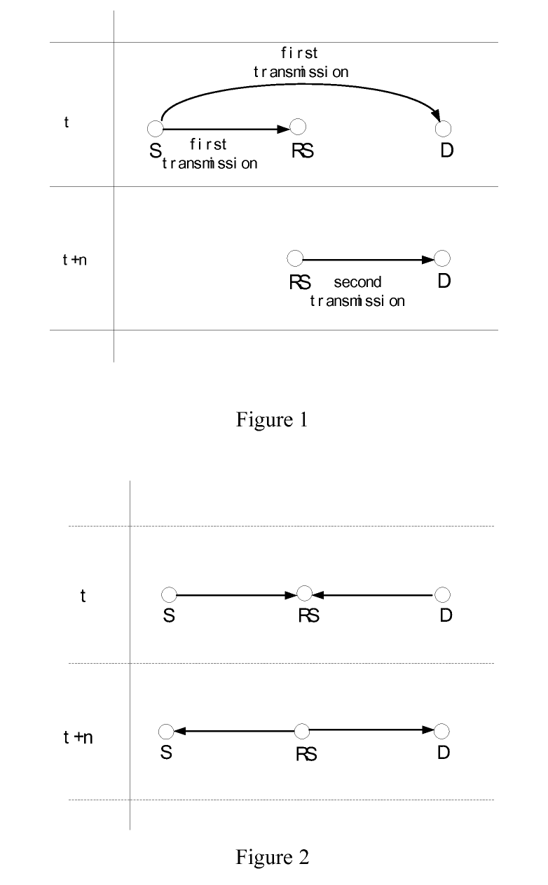

### DESCRIPTION OF THE PREFERRED EMBODIMENTS

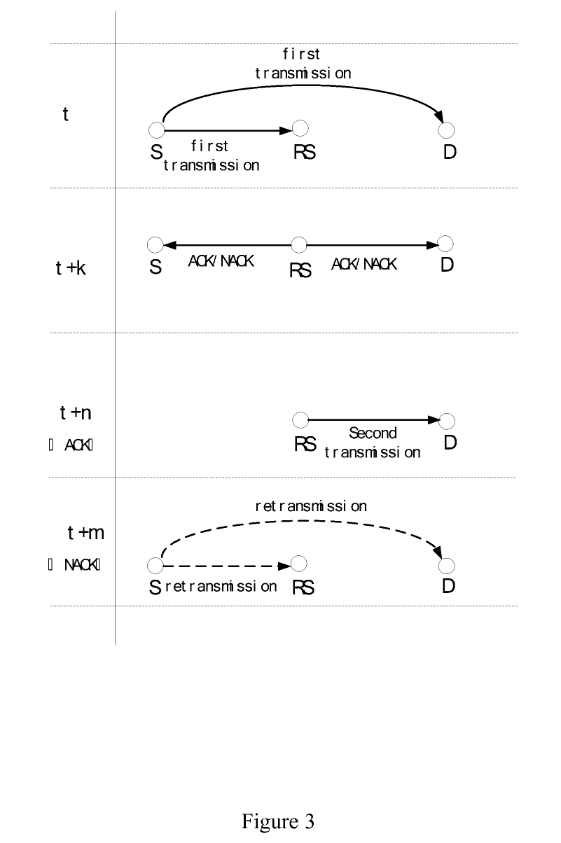

FIG. 3 schematically illustrates a wireless communication method according to one embodiment of the invention. As shown in FIG. 3, at time slot t, a transmitting communication device S performs a first transmission to send a first signal to a relay device RS and a receiving communication device D. The relay device RS decodes the received first signal, determines whether the decoding result is correct, and generates a first decoding response signal indicating whether the decoding result is correct. If the decoding result is correct, the first decoding response signal is an ACK signal, and if the decoding result is not correct, the first decoding response signal is a NACK signal. At time slot t+k, the relay device RS sends the first decoding response signal to the transmitting device S and the receiving communication device D. If the decoding result is correct, the relay device RS performs the second transmission at time slot t+n to forward the first signal to the receiving communication device D. If the decoding result is not correct, the relay device RS does not forward the first signal not correctly decoded at time slot t+n, but receives the retransmitted first signal from the transmitting communication device S at time slot t+m.

In the embodiment, the receiving communication device D may not decode the signal temporarily upon receiving the first signal directly sent from the transmitting communication device S, but wait until receiving the forwarded first signal from the relay device RS and synthesize the two signals to increase the gain of the signal, and then decode the synthesized signal. The method of synthesizing is well known to those skilled in the art, and will not be described herein in detail.

In the embodiment, a parity check as is well known by those skilled in the art may be adopted to determine whether the decoding result is correct, which is not described in detail here.

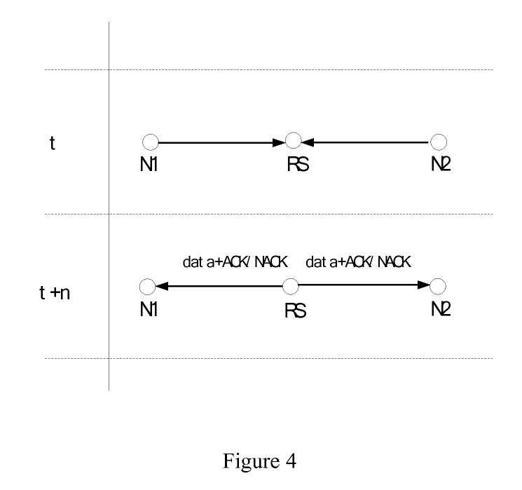

FIG. 4 schematically illustrates a wireless communication method according to another embodiment of the invention. As shown in FIG. 4, the relay device RS receives a first signal from the first communication device N1 destined for the second communication device N2 and a second signal from the second communication device N2 destined for the first communication device N1 simultaneously at time slot t. The relay device decodes the received first and second signals, respectively, determines whether the decoding results are correct, and generates a first decoding response signal and a second decoding response signal. The relay device RS also combines the two decoded signals to obtain a combined signal. In one embodiment, if the decoding results of the first signal and the second signal are both correct, an exclusive OR operation is performed to the decoded first signal and second signal to obtain the combined signal; if only one decoding result of the first signal and the second signal is correct, only the correctly decoded signal is taken as the combined signal; if neither of the decoding result of the first signal and the second signal is correct, the combined signal is a null signal. According to the decoding result of the two data, the relay device RS forwards the combined signal and the first and second decoding response signals to the first communication device N1 and the second communication device N2 simultaneously at time slot t+n.

In the embodiment of FIG. 4, the first communication device N1 and the second communication device N2 can know how to restore the second signal and the first signal through the decoding response signal. For example, if the first decoding response signal and the second decoding response signal both indicate that the decoding result is correct, the first and second communication devices N1 and N2 know that the combined signal is an exclusive OR of the first and second signals. Therefore, the first communication device N1 can perform an exclusive OR operation on the first signal saved by itself and the combined signal so as to restore the second signal. The second communication device N2 perform an exclusive OR operation on the second signal saved by itself and the combined signal so as to restore the first signal. If the first decoding response signal indicates that the decoding result is correct while the second decoding response signal indicates that the decoding result is wrong, the first and second communication devices N1 and N2 know that the combined signal is the first signal. Therefore, the first communication device N1 can perform no process on the signal, while the second communication device N2 can acquire the first signal. If the first decoding response signal and the second decoding response signal both indicate that the decoding result is not correct, both of the first and second communication devices N1 and N2 can perform no process on the signal.

As can be known from the above, compared to the method in which the relay device performs an exclusive OR operation on and forwards the decoded first and second signals no matter whether the decoding result is correct or not, it is possible through the embodiment of FIG. 4 to reduce the amount of computation of the relay device and the first and second communication devices.

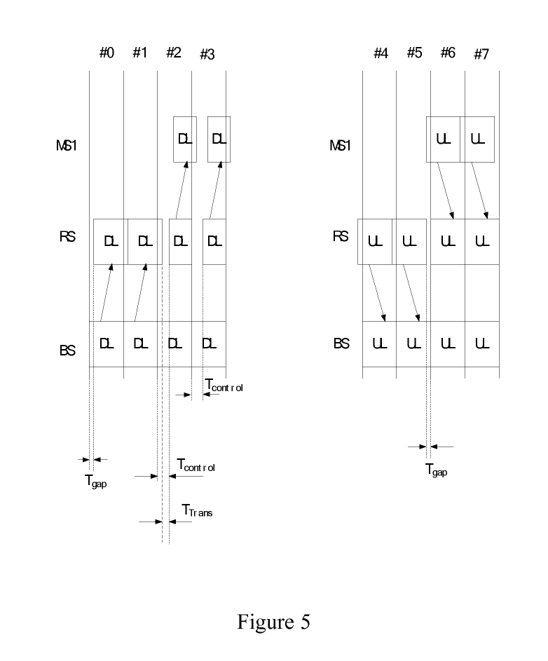

In the following, the embodiment of the invention is described with reference to FIGS. 5-7 with Time Division Duplex (TDD) wireless communication system as an example.

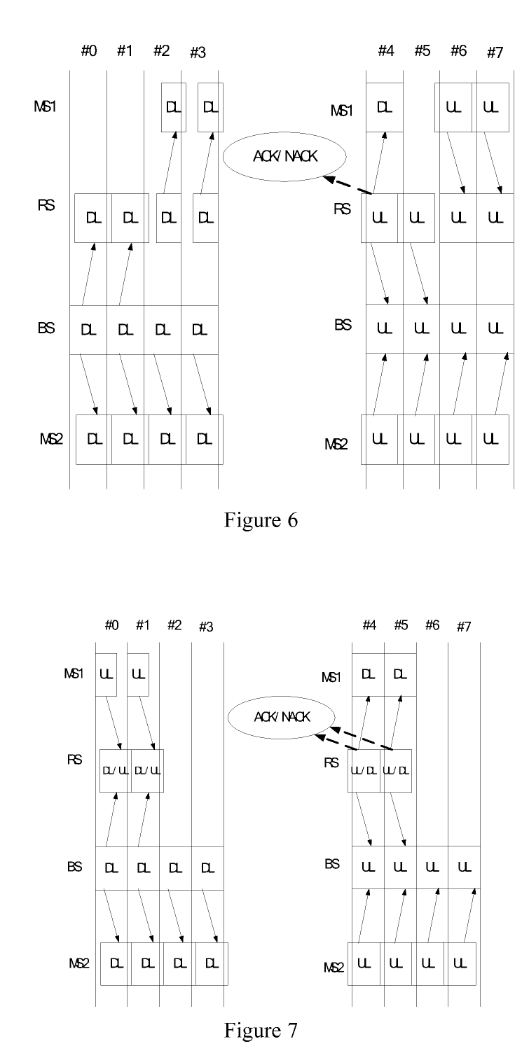

FIG. 5 and FIG. 6 schematically illustrate the time chart of the signal transceiving of the TDD wireless communication system according to one embodiment of the invention. In FIG. 5 and FIG. 6, MS1 is a mobile station requiring relay service, MS2 is a mobile station not requiring relay service (for the sake of clarity, MS2 is not shown in FIG. 5), RS is a relay device, BS is a base station, DL indicates downlink, UL indicates uplink. In this embodiment, one frame includes 4 downlink sub-frames (#0˜#3) and 4 uplink sub-frames (#4˜#7). Here, 4 downlink sub-frames are referred to as a downlink period, and 4 uplink sub-frames is referred to as an uplink period. At the first and second sub-frames of the downlink period (#0 and #1), i.e., a former portion of the downlink period, the relay device RS receives a signal destined for the mobile station MS1 from the base station BS. At the third and fourth sub-frames of the downlink period (#2 and #3), i.e., a latter portion of the downlink period, the relay device RS forwards the signal from the base station BS to the mobile station MS1. At the first and second sub-frames of the uplink (#4 and #5), i.e., a former portion of the uplink period, the relay device RS forwards the signal from the mobile station MS1 to the base station BS. At the third and fourth sub-frames of the uplink period (#6 and #7), i.e., a latter portion of the uplink period, the relay device RS receives the signal destined for the base station BS from the mobile station MS1. Further, in the downlink period, the base station BS also sends a signal to the MS2, and in the uplink period, the base station BS receives a signal from the MS2. In the embodiment, in one frame including an uplink period and a downlink period, the relay device RS only needs to perform twice a switch between a reception state and a transmission state.

In one embodiment, the signal sent from the base station BS includes a data signal and a control signalling. The control signalling includes a scheduling information, which may indicate the relay device RS to forward the data signal with certain time-frequency resources. The relay device RS only needs to forward a data signal and does not need to forward a control signalling when forwarding a signal from the base station BS. As shown in FIG. 5, in the downlink period, as long as a time (T_{control}) occupied by a control signalling is greater than or equal to a sum of a transmission time (T_{gap}) of the data and a time (Tₜᵣₐₙₛ) required for the relay device to switch from a reception state to a transmission state, the relay device RS forwards all data received previously when forwarding data, otherwise, the relay device RS needs to puncture the data and forwards the punctured data. Otherwise, between the second and the third uplink sub-frames of the uplink period, as long as the transmission time(T_{gap}) of the data is greater than or equal to a time (Tₜᵣₐₙₛ) required for the relay device to switch from a transmission state to a reception state, the relay device RS may forward all the data from the mobile station MS1, otherwise, the data needs to be punctured to be forwarded. Here, it is assumed that the time required for the relay device RS to switch from a transmission state to a reception state is equal to the time required for the relay device RS to switch from a reception state to a transmission state. Of course, they two can be unequal. The method to puncture the data is well known to those skilled in the art, which will be omitted herein.

As shown in FIG. 6, at the first and second frames of the uplink period (i.e., #4 and #5), when forwarding the signal from the mobile station Ml to the base station BS, the relay device RS can also send a decoding response signal ACK/NACK to the base station BS and the mobile station MS1 as the relay device RS is in the transmission state at that time.

In the following, the embodiment of FIG. 5 and FIG. 6 is described with reference to FIG. 3.

It is assumed that, in FIG. 3, the transmitting communication device is the base station BS and the receiving communication device is the mobile station MS1. The time slot t in FIG. 3 can correspond to the first or second frame in the downlink period of FIG. 5 and FIG. 6. At time slot t, the base station BS conducts the first transmission, sends the first signal to the relay device RS and the mobile station MS1 (for the sake of clarity, the process that the base station directly sends the first signal to the mobile station MS1 is not shown in FIG. 5 and FIG. 6). The time slot t+k in FIG. 3 can correspond to the first or second frame in the uplink period of the FIG. 5 and FIG. 6. At time slot t+k, the relay device RS sends the first decoding response signal to the base station BS and the mobile station MS1. The reference sign t+n in FIG. 3 can correspond to the third or fourth frame of the next downlink period in FIG. 5 and FIG. 6. At time slot t+n, the relay device RS conducts the second transmission, forwarding the first signal to the mobile station MS1. Time slot t+m in FIG. 3 can correspond to the first or second frame in the next downlink period of FIG. 5 and FIG. 6. At time slot t+m, the base station BS retransmits the first signal. If the mobile station MS1 receives an ACK signal at time slot t+k, it knows that the relay device RS will transmit the first signal at time slot t+n. Therefore, the mobile station MS1 is in the reception state at time slot t+n. And if the mobile station MS1 receives a NACK signal at time slot t+k, it knows that the relay device RS will not retransmit the first signal at time slot t+n. Therefore, the mobile station MS1 can be in a sleep state and does not have to be in the reception state, thereby saving electricity.

It is assumed that, in FIG. 3, the transmitting communication device is the mobile station MS1 and the receiving communication device is the base station BS. The time slot t in FIG. 3 can correspond to the third or fourth frame of the uplink period in FIG. 5 and FIG. 6. At time slot t, the mobile station MS1 conducts the first transmitssion, sending the first signal to the relay device RS and the mobile station BS (for the sake of clarity, the process that the mobile station MS1 directly sends the first signal to the base station BS is not shown in FIG. 5 and FIG. 6). The time slot t+k in FIG. 3 can correspond to the first or second frame of the next uplink period in FIG. 5 and FIG. 6. At time slot t+k, the relay device RS sends the first decoding response signal to the base station BS and the mobile station MS1. The reference sign t+n in FIG. 3 can correspond to the third or fourth frame of the next downlink period in FIG. 5 and FIG. 6. At time slot t+n, the relay device RS transmits for the second time, forwarding the first signal to the base station BS. The time slot t+m in FIG. 3 can correspond to the first or second frame of the next downlink period in FIG. 5 and FIG. 6. At time slot t+m, the mobile station MS1 retransmits the first signal. If the base station receives an ACK signal at time slot t+k, it knows that the relay device RS will transmit the first signal at time slot t+n. Therefore, the base station BS allocates resources for the relay device RS, enabling it to forward the first signal at time slot t+n. And if the base station receives a NACK signal at time slot t+k, it knows that the relay device RS will not forward the first signal at time slot t+n. Therefore, the base station BS can allocate no resource to the relay device RS but to other devices, thereby avoiding a waste of the resources.

It should be noted that though it is shown in FIG. 5 and FIG. 6 that there are eight sub-frames in one frame, including four uplink sub-frames and four downlink sub-frames. The embodiment of the invention is not limited thereto. For example, in one embodiment, one frame can have ten sub-frames, including six downlink sub-frames and four uplink sub-frames. Besides, although in the embodiment the former portion and the latter portion of the downlink period and the uplink period includes two sub-frames, respectively, those skilled in the art can also make adjustment to this according to a particular design.

FIG. 7 schematically illustrates a time chart of the signal transceiving of the TDD wireless communication system according to another embodiment of the invention.

In FIG. 7, MS1 is a mobile station requiring relay service, MS2 is a mobile station not requiring relay service, RS is a relay device, BS is a base station, DL indicates downlink, UL indicates uplink. In the embodiment, one frame includes 8 sub-frames (#0˜#7). The former four sub-frames (#0˜#3) of the 8 sub-frames are referred to as a first period, and the latter four sub-frames (#4˜#7) are referred to as a second period. In FIG. 7, in the first period, the relay device RS receives the first signal from the base station BS and the second signal from the mobile station MS1. In the second period, the relay device RS sends the signal obtained by combining the decoded first and second signal and the first and second decoding response signals together to the base station BS and the mobile station MS1. In one embodiment, if the decoding results of both the first signal and the second signal are correct, an exclusive OR operation is performed on the decoded first and second signals to obtain the combined signal. If only one decoding result of the first signal and the second signal is correct, only the correctly decoded signal is taken as the combined signal. If neither of the decoding result of the first signal and the second signal is correct, the combined signal is a null signal. Besides, the base station BS also sends a signal to the mobile station MS2 in the first period and receives a signal from the mobile station MS2 in the second period.

In the following, the embodiment of FIG. 7 is described with reference to FIG. 4.

The communication devices S and D in FIG. 4 can respectively correspond to the base station BS and the mobile station MS1 in FIG. 7. The time slot t in FIG. 4 can correspond to the first or second frame of the first period in FIG. 7. The time slot t+n in FIG. 4 can correspond to the first or second frame of the second period in FIG. 7.

It should be noted that, although FIG. 7 shows that there are eight sub-frames in one frame and four sub-frames respectively in the first period and the second period, the embodiment of the invention is not limited thereto. For example, in one embodiment, there can be twelve sub-frames in one frame, and there can be six sub-frames in the first period and the second period, respectively.

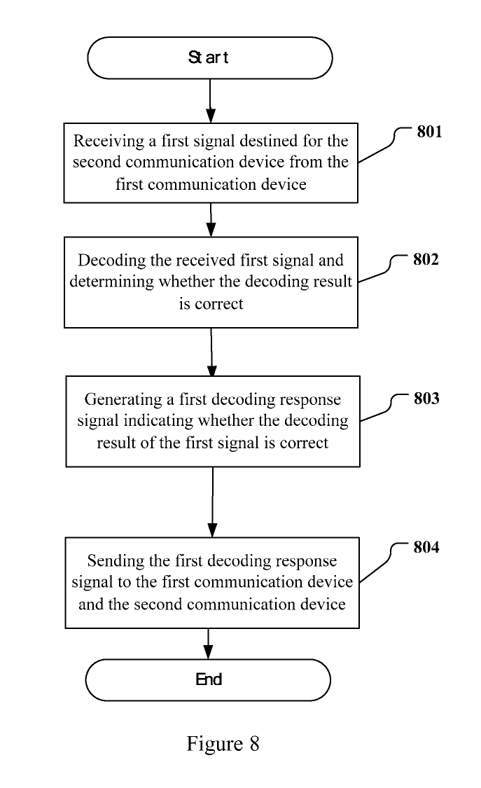

In the following, a flow of a wireless communication method according to a embodiment of the invention is described with reference to FIGS. 8-10.

FIG. 8 is a flow chart of a wireless communication method for a relay device according to one embodiment of the invention. In step 801, a first signal destined for a second communication device is received from a first communication device. In step 802, the received first signal is decoded and the decoding result is determined to be correct or not. In step 803, a first decoding response signal indicating whether the decoding result of the first signal is correct is generated. In step 804, the first decoding response signal is sent to the first communication device and the second communication device. Step 804 can include multiplexing the first decoding response signal with other decoding response signal through time division multiplex, frequency division multiplex, or code division multiplex.

The method shown in FIG. 8 may be utilized in a Time Division Duplex communication system, and the first communication device can be a base station, the second communication device can be a mobile station. The relay device can operate in the following way: in a former portion of the downlink period, receiving a signal destined for the mobile station from the base station; in a latter portion of the downlink period, forwarding the signal from the base station to the mobile station; in a former portion of the uplink period, forwarding a signal from the mobile station to the base station; and in a latter portion of the uplink period, receiving a signal destined for the base station from the mobile station. The above description for FIG. 3, FIG. 5 and FIG. 6 can be referred to for the particular operation details. In addition, the relay device can also operate in the following way: in the first period, receiving a first signal from the base station and a second signal from the mobile station; in the second period, sending a signal obtained by combining the decoded first signal and the decoded second signal and the first decoding response signal and the second decoding response signal together to the base station and the mobile station. The above description for FIG. 4 and FIG. 7 can be referred to for the particular operation details.

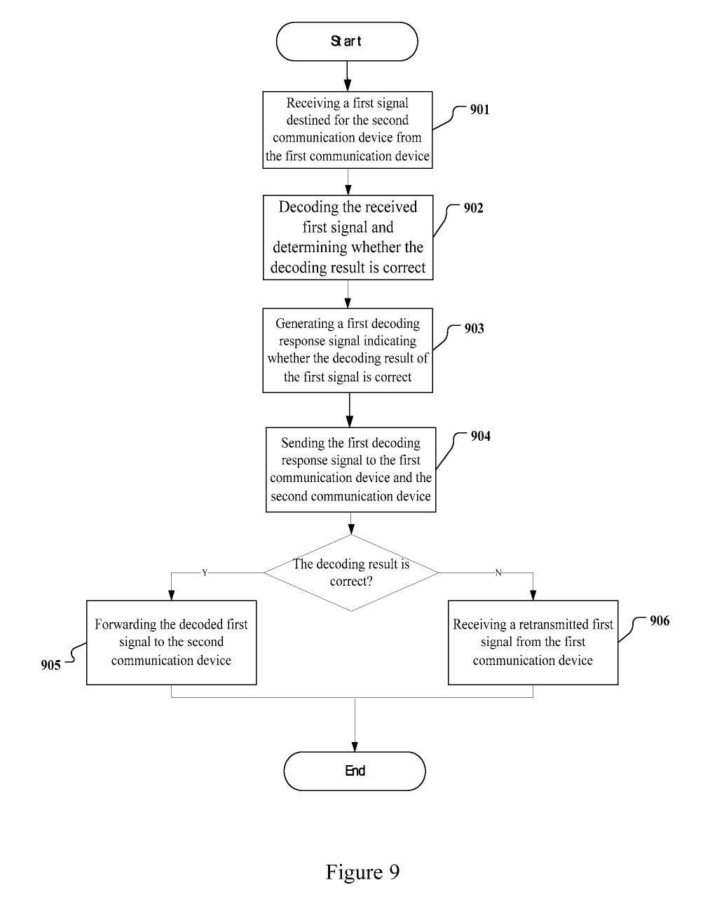

FIG. 9 is a flow chart of a wireless communication method for a relay device according to another embodiment of the invention. In step 901, a first signal destined for the second communication device is received from the first communication device. In step 902, the received first signal is decoded and the decoding result is determined to be correct or not. In step 903, a first decoding response signal indicating whether the decoding result of the first signal is correct or not is generated. In step 904, the first decoding response signal is sent to the first communication device and the second communication device. If in step 902 it is determined that the decoding result is correct, step 905 is executed after step 904. In step 905, the decoded first signal is forwarded to the second communication device. If it is determined that the decoding result is not correct in step 902, step 906 is executed after step 904. In step 906, a retransmitted first signal is received from the first communication device. It should be noted that in step 905, forwarding the decoded first signal to the second communication device can include, for example, a step in which the decoded first signal is recoded, and/or a step in which a control signalling in the first signal is eliminated.

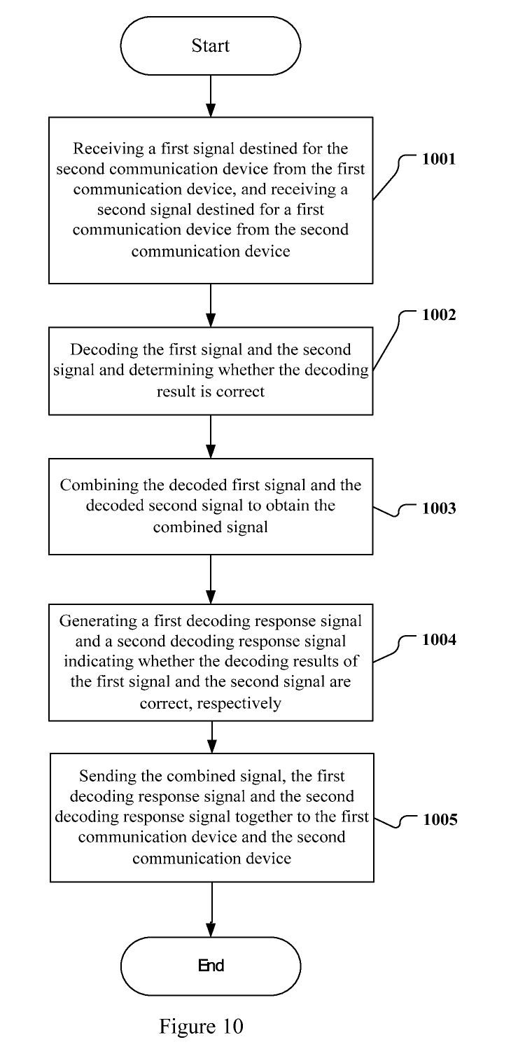

FIG. 10 is a flow chart of a wireless communication method for a relay device according to one embodiment of the invention. In step 1001, a signal destined for the second communication device is received from the first communication device, and a second signal destined for the first communication device is received from the second communication device. In step 1002, the first signal and the second signal are decoded and the decoding result is determined to be correct or not. In step 1003, the decoded first signal and the decoded second signal are combined to obtain the combined signal. In one embodiment, step 1003 includes: if the decoding results of the first signal and the second signal are both correct, an exclusive OR operation is performed to the decoded first signal and the decoded second signal, to obtain the combined signal; if only one decoding result of the first signal and the second signal is correct, the correctly decoded signal is taken as the combined signal; if neither of the decoding result of the first signal and the second signal is correct, the combine signal is a null signal. In step 1004, a first decoding response signal and a second decoding response signal respectively indicating whether the decoding result of the first signal and the second signal are correct are generated. In step 1005, the combined signal and the first decoding response signal and the second decoding response signal are sent together to the first communication device and the second communication device. In step 1005, the first decoding response signal and the second decoding response signal can occupy independent resources. A plurality of decoding response signals can multiplex the resources with, for example, time division multiplex, frequency division multiplex, or code division multiplex. Or the first decoding response signal and the second decoding response signal can share the resources with the combined signal.

FIG. 11 is a block diagram of a relay device 1100 for a wireless communication system according to another embodiment of the invention. In the relay device 1100, the transceiver 1101 is configured to receive a first signal destined for a second communication device from a first communication device. A decoder 1102 is configured to decode the first signal and determine whether the decoding result is correct. A decoding response signal generator 1103 is configured to generate a first decoding response signal indicating whether the decoding result of the first signal is correct. The transceiver 1101 is further configured to send the first decoding response signal to the first communication device and the second communication device.

In one preferred embodiment, the transceiver 1101 can further be configured to forward the first decoding response signal to the second communication device after sending the first decoding response signal to the first communication device and the second communication device when the decoding result of the first signal is correct. In one preferred embodiment, the transceiver 1101 can further be configured to receive a retransmitted first signal from the first communication device after sending the first decoding response signal to the first communication device and the second communication device when the decoding result of the first signal is not correct.

In one preferred embodiment, the relay device 1101 can be used in a Time Division Duplex communication system, the first communication device can be a base station, and the second communication can be a mobile station. The transceiver 1101 can be configured to operate in the following way: in a former portion of the downlink period, receiving a signal destined for the mobile station from the base station; in a latter portion of the downlink period, forwarding the signal from the base station to the mobile station; in a former portion of the uplink period, forwarding a signal from the mobile station to the base station; and in a latter portion of the uplink period, receiving the signal destined for the base station from the mobile station. Preferably, the transceiver 1101 is further configured to send the decoding response signal to the base station and the mobile station in the former portion of the uplink period. The above description for FIG. 3, FIG. 5 and FIG. 6 can be referred to for the particular operation details.

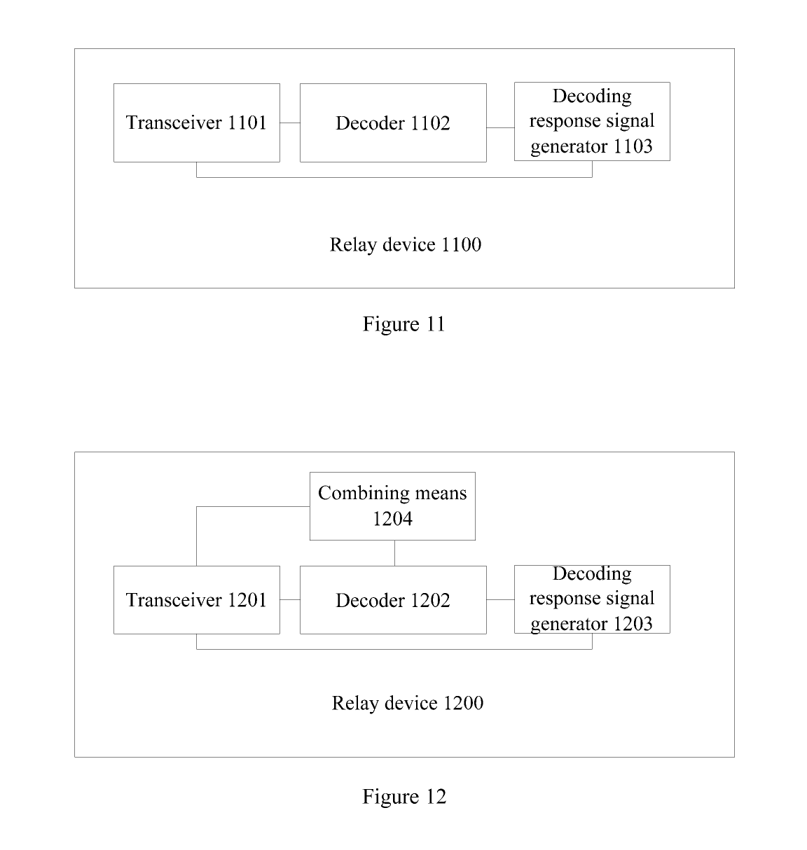

FIG. 12 is a block diagram of a relay device 1200 for a wireless communication system according to another embodiment of the invention. The relay device 1200 includes a transceiver 1201 which is configured to receive a first signal destined for a second communication device from a first communication device and a second signal destined for the first communication device from the second communication device, a decoder 1202 which is configured to decode the received first signal and the second signal and determine whether the decoding result is correct, a decoding response signal generator 1203 which is configured to generate a first decoding response signal indicating whether the decoding result of the first signal is correct and a second decoding response signal indicating whether the decoding result of the second signal is correct, and a combining means 1204 which is configured to combine the decoded first and second signals to obtain the combined signal. In one embodiment, if the decoding result of the first signal and the second signal are both correct, an exclusive OR operation is performed to the decoded first signal and the decoded second signal to obtain the combined signal; if only one decoding result of the first signal and the second signal is correct, the correctly decoded signal is taken as the combined signal; if neither of the decoding result of the first signal and the second signal is correct, the combined signal is a null signal. The transceiver 1201 is further configured to send the combined signal and the first decoding response signal and the second decoding response signal to the first communication device and the second communication device.

Preferably, the relay device 1200 can be used in a Time Division Duplex communication system, and the first communication device can be a base station, the second communication device can be a mobile station, and the transceiver 1201 is configured to operate in the following way: in the first period, receiving a first signal from the base station and a second signal from the mobile station; in the second period, sending the above combined signal and the first and second decoding response signals to the base station and the mobile station.

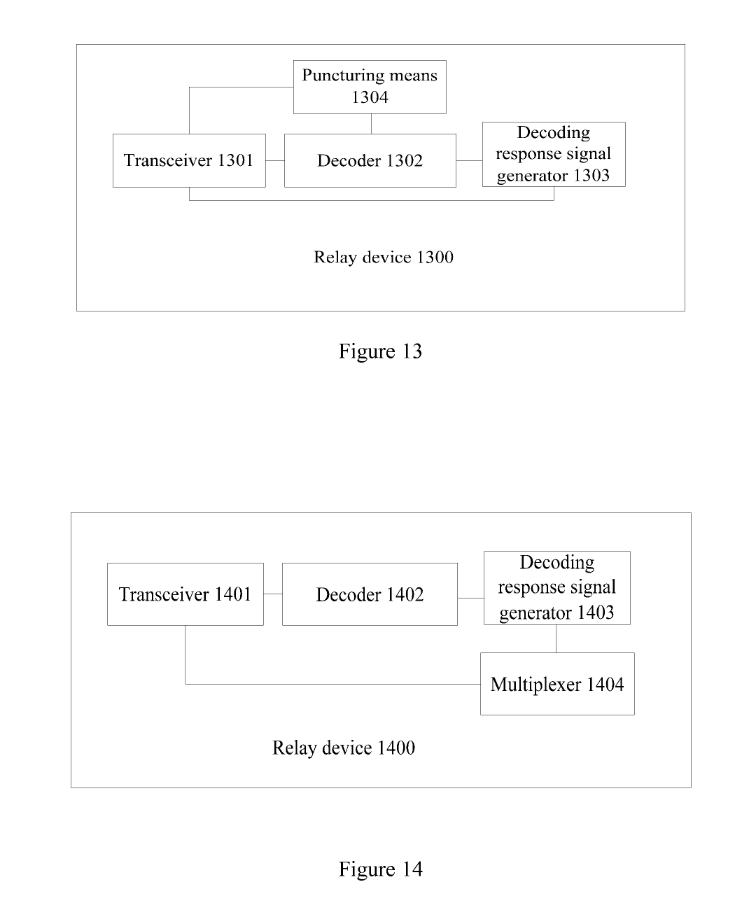

FIG. 13 is a block diagram of a relay device 1300 for a wireless communication system according to another embodiment of the invention. The relay device 1300 includes a transceiver 1301, a decoder 1302, a decoding response signal generator 1303, and a puncturing means 1304. The transceiver 1301, the decoder 1302 and the decoding response signal generator 1303 are similar to the transceiver 1101, the decoder 1102 and the decoding response signal generator 1103 in FIG. 11, which will not be described in detail herein. The relay device 1301 can be used in a Time Division Duplex communication system, the first communication device can be a base station, and the second communication device can be a mobile station. The transceiver 1301 can be configured to operate in the following way: in a former portion of the downlink period, receiving a signal destined for the mobile station from the base station; in a latter portion of the downlink period, forwarding the signal from the base station to the mobile station; in a former portion of the uplink period, forwarding a signal from the mobile station to the base station; and in a latter portion of the uplink period, receiving the signal destined for the base station from the mobile station. When a time length of a control signalling in the signal from the base station is greater than or equal to a sum of a transmission time of the data in the signal from the base station and a required time for the relay device to switch from a reception state to a transmission state, the transceiver 1301 forwards all data in the signal from the base station, otherwise, the puncturing means 1304 punctures the data in the signal from the base station, and the transceiver 1301 forwards the punctured data. In addition, when a transmission time of the data in the signal from the mobile station is greater than or equal to the time required for the relay device to switch from a transmission state to a reception state, the transceiver forwards all the data in the signal from the mobile station. Otherwise, the puncturing means 1304 punctures the data in the signal from the mobile station, and then the transceiver 1301 forwards the punctured data.

FIG. 14 is a block diagram of a relay device 1400 for a wireless communication system according to another embodiment of the invention. The relay device 1400 includes a transceiver 1401, a decoder 1402, a decoding response signal generator 1403 and a multiplexer 1404. The transceiver 1401, the decoder 1402 and the decoding response signal generator 1403 are similar to the transceiver 1101, the decoder 1102 and the decoding response signal generator 1103 in FIG. 11, which will not be described in detail herein. The multiplexer 1404 is configured to multiplex a plurality of decoding response signals through time division multiplex, frequency division multiplex, or code division multiplex.

For those skilled in the art, it should be understood that the whole of the method and device of the invention or any step or part can be realized with hardware, firmware, software or their combination in any computing device (including processor, storage medium, etc) or a network of the computing devices, which can be realized by those skilled in the art with their basic programming techniques after reading the description of the invention, and thus the detailed description of which is omitted herein.

Therefore, based on the above understanding, the object of the invention can further be achieved by running one program or a group of programs on any information processing device. The information processing device can be a well-known general-purpose device. Therefore, the object of the invention can also be achieved by only providing a program product including a program code that realizes the method or device. That is, such a program product also constitutes the invention, and a storage media storing such a program product also constitutes the invention. Obviously, the storage media can be any well-known storage media or any storage media to be developed in the future. Therefore, there is no need to list various storage media one by one herein.

It is obvious that, in the device and method of the invention, each part or each step can be decomposed, combined, and/or recombined after being decomposed. Such a decomposition, combination and/or recombination shall be deemed as equivalent scheme for the invention.

The preferred embodiment of the invention is described in the above. It is known to those skilled in the art that the protection scope of the invention is not limited to those disclosed in detail here, but can include various modifications and equivalent schemes within the scope of the spiritual essence of the invention.

1. A wireless communication method for a relay device, comprising:
receiving a first signal destined for a second communication device from a first communication device;
decoding the received first signal and determining whether a decoding result is correct;
generating a first decoding response signal indicating whether the decoding result of the first signal is correct; and
sending the first decoding response signal to the first communication device and the second communication device.

2. The method of claim 1, further comprising:
forwarding the first signal to the second communication device after sending the first decoding response signal to the first communication device and the second communication device if the decoding result of the first signal is correct.

3. The method of claim 2, further comprising:
receiving the first signal retransmitted from the first communication device after sending the first decoding response signal to the first communication device and the second communication device if the decoding result of the first signal is not correct.

4. The method of claim 1, further comprising:
receiving a second signal destined for the first communication device from the second communication device when receiving the first signal from the first communication device;
decoding the second signal and determining whether a decoding result is correct;
generating a second decoding response signal indicating whether the decoding result of the second signal is correct;
combing the first signal decoded and the second signal decoded to obtain a combined signal; and
sending the combined signal and the second decoding response signal to the first communication device and the second communication device together with the sending of the first decoding response signal.

5. The method of claim 4, wherein combing the first signal decoded and the second signal decoded to obtain a combined signal comprising:
if both the decoding results of the first signal and the second signal are correct, performing an exclusive OR operation to the first signal decoded and the second signal decoded to obtain the combined signal;
if only one of the decoding results of the first signal and the second signal is correct, obtaining the signal decoded correctly as the combined signal; and
if neither of the decoding results of the first signal and the second signal is correct, obtaining a null signal as the combined signal.

6. The method of claim 1, wherein, the method is used in a TDD (Time Division Duplex) communication system, and the first communication device is a base station, the second communication device is a mobile station,
the relay device operates according to the following pattern:
receiving a signal destined for the mobile station from the base station in a former part of a downlink period;
forwarding a signal originated from the base station to the mobile station in a latter part of the downlink period;
forwarding a signal originated from the mobile station to the base station in a former part of a uplink period; and
receiving a signal destined for the base station from the mobile station in a latter part of the uplink period.

7. The method of claim 6, wherein if a time length of a control signalling in the signal originated from the base station is greater than or equal to a sum of a transmission time of the data in the signal originated from the base station and a required time for the relay device to switch from a reception state to a transmission state, the relay device forwards all data in the signal originated from the base station, otherwise, the relay device punctures the data in the signal originated from the base station and forwards the punctured data.

8. The method of claim 6, wherein if a transmission time of data in the signal originated from the mobile station is greater than or equal to a required time for the relay device to switch from a transmission state to a reception state, the relay device forwards all data in the signal originated from the mobile station, otherwise, the relay device punctures the data in the signal originated from the mobile station and forwards the punctured data.

9. The method of claim 6, wherein, in the former part of the uplink period, the relay device sends the decoding response signal to the base station and the mobile station.

10. The method of claim 4, wherein, the method is used in a TDD communication system, and the first communication device is a base station, the second communication device is a mobile station,
the relay device operates according to the following pattern:
in a first period, receiving the first signal originated from the based station and the second signal originated from the mobile station;
in a second period, sending the combined signal to the base station and the mobile station together with the first decoding response signal and the second decoding response signal.

11. The method of claim 1, wherein the step of sending the first decoding response signal comprises multiplexing the first decoding response signal with other decoding response signal(s) through time division multiplex, frequency division multiplex, or code division multiplex.

12. The method of claim 4, wherein, in the step of sending the combined signal, the first decoding response signal and second decoding response signal to the first communication device and the second communication device, the first decoding response signal and second decoding response signal occupy separate resources or share resources with the combined signal.

13. A relay device used in a wireless communication system, comprising:
a transceiver configured to receive a first signal destined for a second communication device from a first communication device;
a decoder configured to decode the first signal and determine whether a decoding result is correct;
a decoding response signal generator configured to generate a first decoding response signal indicating whether the decoding result of the first signal is correct,
wherein, the transceiver is further configured to send the first decoding response signal to the first communication device and the second communication device.

14. The relay device of claim 13, wherein, the transceiver is further configured to forward the first signal to the second communication device after sending the first decoding response signal to the first communication device and the second communication device if the decoding result of the first signal is correct.

15. The relay device of claim 14, wherein, the transceiver is further configured to receive the first signal retransmitted from the first communication device after sending the first decoding response signal to the first communication device and the second communication device if the decoding result of the first signal is not correct.

16. The relay device of claim 13, wherein, the transceiver is further configured to receive a second signal destined for the first communication device from the second communication device when receiving the first signal from the first communication device, the decoder is further configured to decode the second signal and determine whether a decoding result is correct, and the decoding response signal generator is further configured to generate a second decoding response signal indicating whether a decoding result of the second signal is correct,
the relay device further comprises a combining means configured to combine the first signal decoded and the second signal decoded to obtain a combined signal,
the transceiver is further configured to send the combined signal and the second decoding response signal to the first communication device and the second communication device together with the sending of the first decoding response signal.

17. The relay device of claim 16, wherein the combining means is configured to perform a exclusive OR operation to the first signal decoded and the second signal decoded to obtain the combined signal if the decoding results of the first signal and the second signal are both correct, to obtain a signal decoded correctly as the combined signal if only one of the decoding results of the first signal and the second signal is correct, and to obtain a null signal as the combined signal if neither of the decoding results of the first signal and the second signal is correct.

18. The relay device of claim 13, wherein, the relay device is used in a TDD communication system, and the first communication device is a base station, the second communication device is a mobile station,
the transceiver is configured to operate according to the following pattern:
receiving a signal destined for the mobile station from the base station in a former part of a downlink period;
forwarding a signal originated from the base station to the mobile station in a latter part of the downlink period;
forwarding a signal originated from the mobile station to the base station in a former part of a uplink period;
receiving a signal destined for the base station from the mobile station in a latter part of the uplink period.

19. The relay device of claim 18, wherein the relay device further comprises a puncturing means, and if a time length of a control signalling in the signal originated from the base station is greater than or equal to a sum of a transmission time of data in the signal originated from the base station and a required time for the relay device to switch from a reception state to a transmission state, the transceiver forwards all data in the signal originated from the base station, otherwise, the puncturing means punctures the data in the signal originated from the base station and the transceiver forwards the punctured data.

20. The relay device of claim 18, wherein the relay device further comprises a puncturing means, and if a transmission time of data in the signal originated from the mobile station is greater than or equal to a required time for the relay device to switch from a transmission state to a reception state, the transceiver forwards all data in the signal originated from the mobile station, otherwise, the puncturing means punctures the data in the signal originated from the mobile station and the transceiver forwards the punctured data.

21. The relay device of claim 18, wherein, the transceiver is configured to send a decoding response signal to the base station and the mobile station in the former part of the uplink period.

22. The relay device of claim 16, wherein, the relay device is used in a TDD communication system, and the first communication device is a base station, the second communication device is a mobile station,
the transceiver is configured to operate according to the following pattern:
receiving the first signal originated from the base station and the second signal originated from the mobile station in a first period;
sending the combined signal and the first decoding response signal and the second decoding response signal to the base station and the mobile station in a second period.

23. The relay device of claim 13, further comprising a multiplexer configured to multiplex a plurality of decoding response signals through time division multiplex, frequency division multiplex, or code division multiplex.
